(19) United States
(12) Patent Application Publication
(10) Pub. No.: US 2012/0064481 A1
(43) Pub. Date: Mar. 15, 2012

(54) COMPOSITE DELIVERY SYSTEM

(76) Inventors: Wade Cannon, Orem, UT (US); Bruce S. McLean, Sandy, UT (US); Dan E. Fischer, Sandy, UT (US)

(21) Appl. No.: 13/231,717

(22) Filed: Sep. 13, 2011

Related U.S. Application Data
(60) Provisional application No. 61/382,079, filed on Sep. 13, 2010.

(51) Int. Cl. A61C 5/04

(52) U.S. Cl. 433/90

(57) ABSTRACT

A syringe delivery system for dispensing a highly viscous material through a syringe delivery opening includes a syringe barrel having a delivery opening, a plunger stem including a threaded shaft that threadably engages a proximal end of the syringe barrel for selectively dispensing a viscous material through the delivery opening, and a sheath. The sheath is rigidly attached with the plunger stem so that the plunger stem and sheath rotate together in unison relative to the syringe barrel. The sheath and syringe barrel may enclose the plunger stem. In order to dispense a viscous material, the syringe barrel is rotated relative to the sheath, causing the syringe barrel to be progressively received within the sheath and simultaneously forcing the plunger stem further into the syringe barrel so as to dispense a viscous material from the delivery opening.

### CROSS-REFERENCE TO RELATED APPLICATIONS

The present application claims the benefit of U.S. Provisional Patent Application Ser. No. 61/382,079 filed Sep. 13, 2010 and entitled COMPOSITE DELIVERY SYSTEM, herein incorporated by reference in its entirety.

### BACKGROUND

1. The Field of the Invention

The present invention relates to syringe systems that are used for storing and dispensing materials therefrom. More particularly, the present invention relates to a dental syringe system that provides for controllable doses of a highly viscous, pliable, curable (e.g., light-activated) dental composite.

2. The Relevant Technology

Cosmetic and/or functional augmentations of a tooth due to chipping or decay are common dental procedures. Typically, the dentist will apply a resin-based, light-activated dental composite to the tooth in order to fill a chipped or missing area. When the dental composite closely matches the natural color of the tooth, the repair job is barely, if at all, noticeable.

Typically, the dental composite is stored and dispensed from a syringe that is constructed to progressively extrude the composite material. Typically, only a small amount of the dental composite within a syringe is used for each patient, and there may be a risk of cross contamination from one patient to the next. In addition, many existing syringe designs may allow entry of foreign debris into the internal structures of the syringe system, which may lead to contamination of stored uncured light curable composite material and/or accumulation of dirt and debris within crevices of the syringe components.

### BRIEF SUMMARY

The present invention is directed to a syringe delivery system for dispensing a highly viscous material through a syringe delivery opening. The system includes a syringe barrel having an exterior gripping surface, a hollow interior chamber for holding a viscous material, and a delivery opening at a distal delivery end of the barrel through which the viscous material is dispensed. The system further includes a plunger stem including a threaded shaft that threadably engages corresponding threads at the proximal end of the syringe barrel. The plunger stem is at least partially disposed within the hollow interior chamber of the syringe barrel, and is selectively longitudinally advanceable therein so as to dispense the viscous material from the hollow interior chamber through the delivery opening. A sheath covers at least the proximal end of the threaded shaft of the plunger stem so that the entire plunger stem is sealed within the syringe barrel and sheath during use. The sheath and plunger stem are rigidly attached to one another so that the plunger stem rotates with the sheath, and the sheath longitudinally advances together with the plunger stem relative to the syringe barrel as the sheath and syringe barrel are rotated relative to one another. An interior chamber within the sheath receives the diametrically smaller proximal end of the syringe barrel as the plunger stem including the threaded shaft advances within the syringe barrel to dispense viscous material through the delivery opening.

As a result of this configuration, as the viscous material is progressively dispensed (i.e., by rotating the syringe barrel relative to the sheath), the overall length of the delivery system is progressively reduced as viscous material is dispensed. Thus, the length of the delivery system is greatest when new, before any viscous material has been dispensed and the plunger stem has not been advanced to any significant degree within the syringe barrel. The length of the delivery system is shortest when all of the viscous material within the hollow interior chamber that can be dispensed has been dispensed, and the plunger stem has been fully advanced into the syringe barrel as far as it is able. Shortening of the device length occurs as a result of the syringe barrel being progressively advanced into the sheath as the plunger stem simultaneously advances into the syringe barrel. In other words, more of the syringe barrel is progressively enclosed within the interior chamber of the sheath as more viscous material is dispensed, and the increase in overlap between the syringe barrel and sheath results in progressive shortening of the overall length of the syringe system.

These and other benefits, advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary syringe delivery system;

FIG. 2 is a cross sectional view of the syringe delivery system of FIG. 1;

FIG. 3 is an exploded view of the exemplary syringe delivery system of FIG. 1;

FIG. 4 is a cross-sectional view similar to that of FIG. 2, but in which the plunger stem has been advanced further into the syringe barrel, resulting in increased overlap of the syringe barrel with the sheath; and

FIG. 5 is a cross-sectional view similar to that of FIG. 4, but in which the plunger stem has been fully advanced into the syringe barrel, resulting in maximum overlap (and minimum overall system length) of the syringe barrel length with the sheath.

### DETAILED DESCRIPTION

### I. Introduction

The invention generally relates to a syringe delivery system for dispensing a viscous material through a syringe delivery opening. The syringe delivery system includes a syringe barrel, a plunger stem, and a sheath. The syringe barrel includes an exterior gripping surface and a hollow interior chamber for holding a viscous material to be dispensed, as well as a delivery opening at the distal delivery end of the barrel through which the viscous material is dispensed. The plunger stem includes a threaded shaft that threadably engages corresponding threads at the proximal end of the syringe barrel so that the plunger stem is at least partially disposed within the hollow interior chamber of the syringe barrel. The plunger stem is selectively longitudinally advanceable within the syringe barrel so as to dispense the viscous material from the interior chamber through the delivery opening. The sheath covers at least the proximal end of the threaded shaft of the plunger stem so that the entirety of the plunger stem is sealed within the syringe barrel and sheath during use, preventing foreign debris and/or other contaminants from contacting the plunger stem or viscous material contained within the interior chamber.

The sheath and plunger stem are rigidly attached to one another so that the sheath and plunger stem both rotate in unison relative to the syringe barrel. As the sheath and plunger stem are rotated in a given direction, the plunger stem can be longitudinally advanced further into the syringe barrel as the proximal end of the syringe barrel progressively advances further into the interior chamber of the sheath. The proximal end of the syringe barrel is diametrically smaller relative to the sheath into which it is received and progressively advanced. During such rotation, advancement of the plunger within the interior chamber of the syringe barrel forces the viscous material contained therein through the delivery opening. Rotating the sheath and plunger stem in the opposite direction causes the plunger system to be progressively withdrawn from the syringe barrel.

### II. Exemplary Syringe Delivery Systems

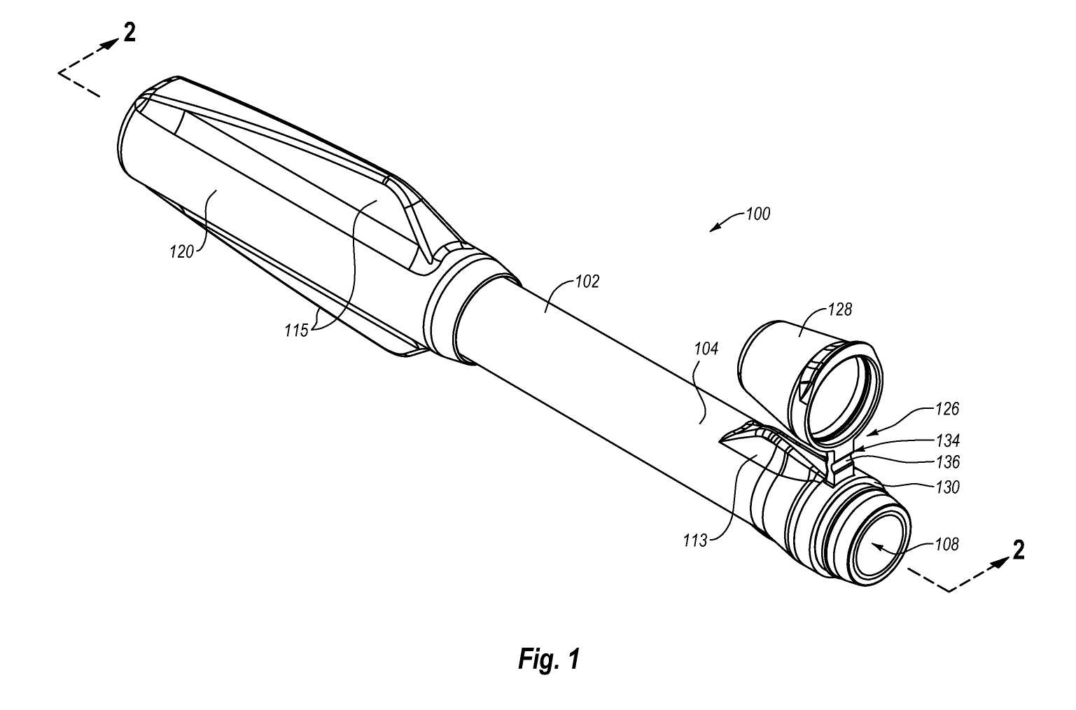

FIGS. 1-3 illustrate an exemplary syringe delivery system 100. System 100 includes a syringe barrel 102 including an outer gripping surface 104, a hollow interior chamber 106, and a delivery opening 108 at the distal end of barrel 102. System 100 further includes a plunger stem 110. In one embodiment, plunger stem 110 includes a threaded shaft portion 112, a proximal end 114 that is fixed relative to sheath 120, and a distal end 116 including a plunger 118 disposed over distal end 116. Distal end 116 is illustrated as being unthreaded but may be threaded if desired. Plunger 118 is diametrically sized so as to force a composite or other viscous material 122 within internal chamber 106 out through delivery opening 108 as syringe barrel 102 is advanced into sheath 120.

Sheath 120 may be rigidly attached with proximal portion 114 of plunger stem 110, and sheath 120 covers at least the proximal end of threaded shaft 112. Rigid attachment of plunger stem 110 to sheath 120 causes plunger stem 110 to rotate in unison with sheath 120 relative to syringe barrel 102. As seen in FIG. 1, a pair of optional torque fins 113 may be disposed on the outer gripping surface 104 of syringe barrel 102 (e.g., near the distal end of barrel 102). Another pair of optional torque fins 115 may be disposed along the exterior surface of sheath 120. Elongate torque fins 113, 115 aid the user in gripping and rotating sheath 120 relative to syringe barrel 102 relative to sheath 120.

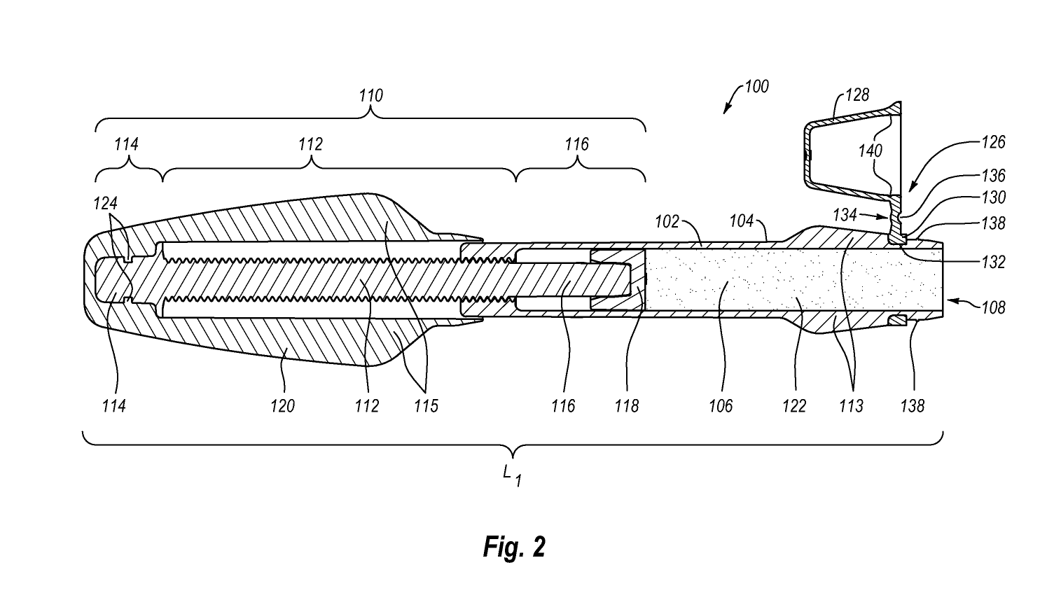

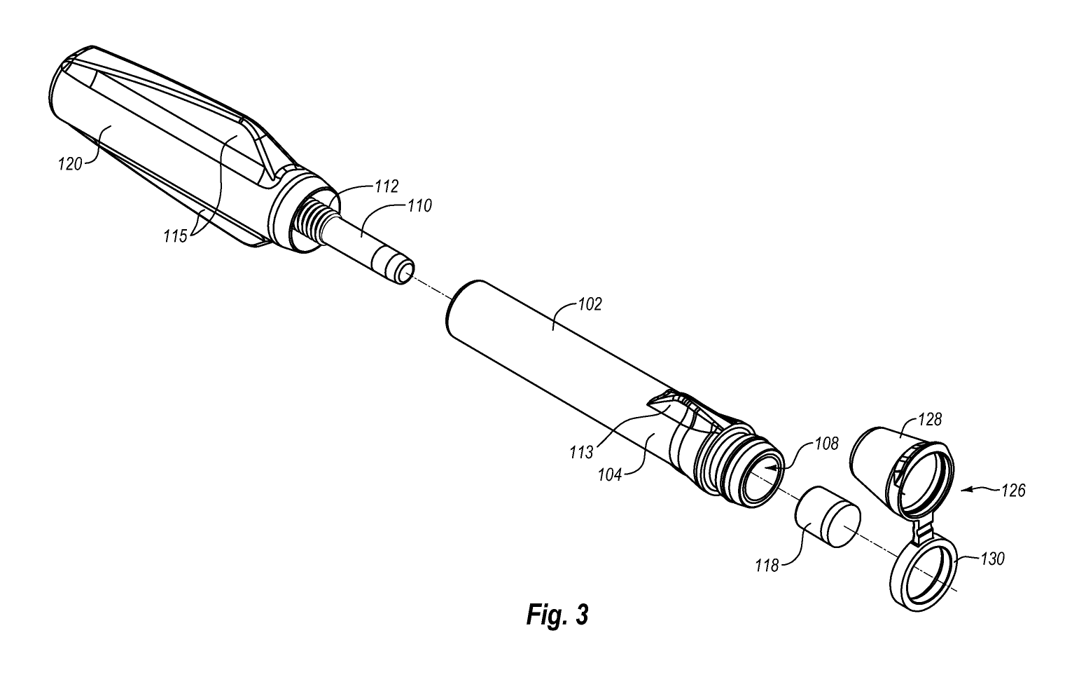

As seen in FIGS. 2 and 3, distal end 116 of plunger stem 110, as well as a distal part of threaded shaft 112 may extend longitudinally out from sheath 120. As seen in FIG. 2, when substantially no viscous material 122 has been dispensed (i.e., system 100 is new), this distal part of threaded shaft 112 is threadably coupled within the proximal end of syringe barrel 102, while unthreaded distal end 116 extends into internal chamber 106. Plunger 118 is advantageously constructed of an elastomeric material on its sides to contact the inner wall of syringe barrel 102 and has a distal end surface that contacts viscous material 122, forcing it distally towards opening 108 as syringe barrel 102 and sheath 120 are rotated relative to one another in a given direction (e.g., clockwise).

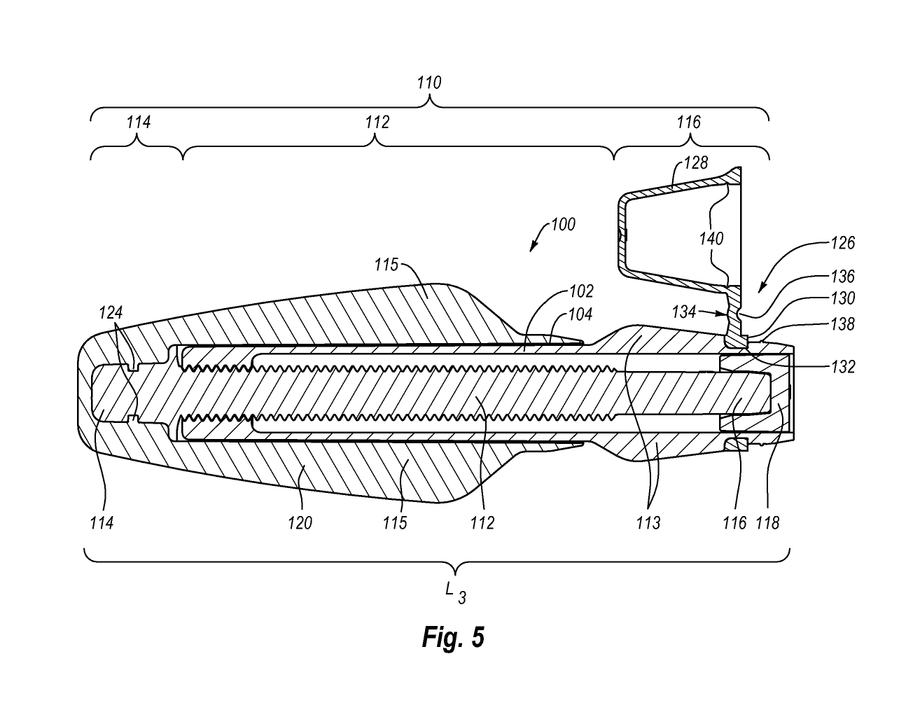

Sheath 120 may comprise a hollow generally cylindrical shaped body in which the plunger stem 110 is disposed within the hollow interior cavity of the sheath body. The hollow interior cavity of sheath 120 may be configured as an elongate centrally disposed longitudinal cavity that has an inside diameter, and syringe barrel 102 may include a proximal portion having an outside diameter that is approximately equal to or slightly less than the inside diameter of the hollow interior cavity of sheath 120. In this way, the distal end of the sheath 120 can substantially seal against the outer surface of syringe barrel 102. Furthermore, as perhaps best seen in Figure 5, a depth of the hollow interior cavity of sheath 120 may be approximately equal to a length of the proximal portion of the syringe barrel 102.

As shown in FIG. 2, the proximal end 114 of plunger stem 110 may include a radial groove 124 into which a corresponding mating protrusion of the body of sheath 120 is received so that proximal end 114 of plunger stem can be rigidly attached relative to sheath 120. Because proximal end 114 and sheath 120 can be rigidly attached, as a user rotates sheath 120 relative to syringe barrel 102, plunger stem 110 rotates with sheath 120. Other mechanisms of rigid attachment between proximal end 114 and plunger stem 110 may be employed, for example another mechanical attachment mechanism, and/or use of a suitable adhesive so as to fix proximal end 114 and sheath 120 relative to one another. Various alternative attachment means known in the art will be apparent to one of skill in the art in light of the present disclosure.

As perhaps best seen in FIGS. 2 and 3, the central threaded portion 112 and distal portion 116 of plunger stem 110 may not be directly attached to sheath 120. For example, as perhaps best seen in FIG. 2, these structures may extend longitudinally through the hollow interior of the generally cylindrical body of sheath 120, while being spaced apart from the body of sheath 120. The unthreaded portion 116 and a portion of threaded portion 112 can be received within syringe barrel 102.

A flip-top or other cap 126 may be provided for selectively covering delivery opening 108. Exemplary flip-top cap 126 may include a cap portion 128 hingedly attached to a retaining ring 130. A radial groove 132 formed near the distal delivery end 108 of syringe barrel 102 may be provided to mate with ring 130 so that ring 130 is matingly received within groove 132. Cap portion 128 may be connected to ring 130 by a hinge 134 including a region of reduced cross-sectional thickness 136. For example, region 136 has a reduced cross-sectional thickness relative to regions of hinge 134 that are immediately adjacent to region 136. Such a configuration provides a line or region along which hinge 134 is configured to bend, so as to allow cap 128 to be hingedly closed over delivery opening 108. A locking radial rim 138 and corresponding radial groove 140 may be provided within the distal end of syringe barrel 102 and cap 128, respectively, so as to retain cap 128 in a closed position once rim 138 and groove 140 engage one another. In one embodiment, such a locking mechanism tends to bias cap 128 closed over opening 108 when in locked engagement, while cap 128 may be biased open by hinge element 134 (e.g., as shown in FIG. 2) so as to not occlude opening 108 when not in locked engagement. In the illustrated configuration, rim 138 is provided on syringe barrel 102 while groove 140 is provided within cap 128. It will be appreciated, however, that the locations of such locking structures could alternatively be reversed. In addition, alternative locking means known in the art and that will be apparent to one of skill in the art may alternatively be used.

In one configuration, at least syringe barrel 102 may be formed of a material that blocks transmission of curing light wavelengths so as to prevent premature curing of a light curable viscous material 122 stored within interior chamber 106. Sheath 120 may also be made of a curing wavelength blocking material for added safety. Sheath 120 may include a transparent window through which volume indicating marks on an outer surface of barrel 102 (not shown) are visible.

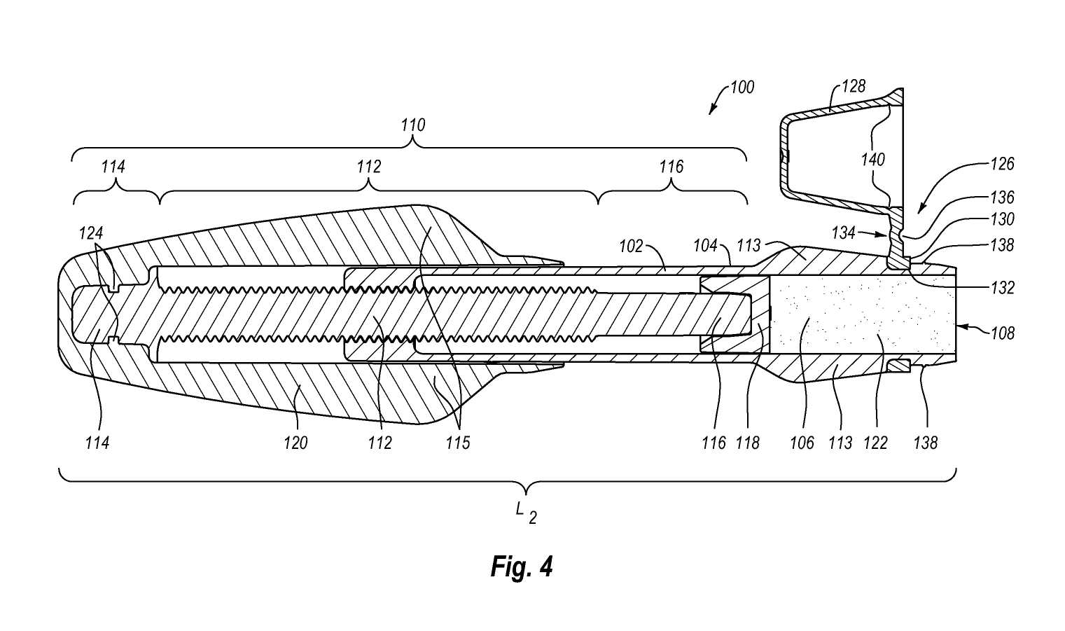

FIGS. 4 and 5 illustrate similar cross-sectional views as shown in FIG. 2, although at differing degrees of progressive advancement of syringe barrel 102 into sheath 120 and plunger 118 through barrel 102. For example, in the configuration shown in FIG. 2, syringe barrel 102 is nearly removed from sheath 120. Although sheath 120 provides little or no support and/or guidance to syringe 102 in this configuration, the sheath 120 may be stabilized as a result of plunger stem 110 being threadably engaged within the proximal end of syringe barrel 102. This configuration may be exemplary of a condition when system 100 is new, not yet having been used to dispense any of viscous material 122.

As shown, the system 100 has an overall length L1. In Figure 4, syringe barrel 102 has been rotated relative to sheath 120 such that more of the proximal end of syringe barrel 102 has been received into the distal end of sheath 120, resulting in a shortening of the overall length of device 100. At this stage, about half of the viscous material 122 may have been dispensed, and the overall length is L2, shorter than L1. The difference between L1 and L2 is equal to the additional length of syringe barrel 102 that has been received within sheath 120, resulting in more overlap of syringe barrel 102 with sheath 120. In FIG. 5, substantially all of viscous material 122 has been dispensed, such that chamber 106 is now substantially devoid of viscous material. Even more of syringe barrel 102 has been received into sheath 120, such that the length of the hollow interior cavity of sheath 120 is now substantially occupied by syringe barrel 102. In this configuration, the length of system 100 is only L3, less than both L1 and L2.

In one embodiment, the ratio of L1 to L3 is between about 2:1 and about 1.25:1, more preferably between about 1.75:1 and about 1.5:1. For example, in the illustrated configuration, the ratio of L1 to L3 may be about 1.55:1. The shortening of the overall length of system 100 is advantageous, as it provides the user with a visual indication of how much viscous material 122 remains within chamber 106, even when syringe barrel 102 is not transparent. In addition, the configuration is relatively simple, capable of being manufactured at low cost, for example, without requiring the use of any complex level indicator components in order to ascertain the approximate volume of viscous material 122 remaining. Elimination of cumbersome or complex level indicators greatly simplifies manufacture

As used in this specification and the appended claims, the singular forms “a,” “an” and “the” include plural referents unless the context clearly dictates otherwise.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A syringe delivery system for dispensing a viscous material through a syringe opening comprising:
a syringe barrel having an outer gripping surface, a hollow interior chamber for holding a viscous material to be dispensed, and a delivery opening at a delivery end of the barrel through which the viscous material may be dispensed;
a plunger stem including a threaded shaft that threadably engages the syringe barrel, the plunger stem being at least partially disposed within the hollow interior chamber of the syringe barrel for selective longitudinal advancement therein so as to dispense a viscous material from the interior chamber through the delivery opening; and
a sheath that covers at least the proximal end of the threaded shaft of the plunger stem so that the plunger stem is entirely enclosed within the syringe barrel and the sheath during use, the sheath and plunger stem being rigidly attached to one another so that the plunger stem rotates in unison with the sheath relative to the syringe barrel, and the syringe barrel advances into the sheath so that the plunger stem simultaneously advances within the hollow interior chamber as the sheath progressively receives the syringe barrel when dispensing a viscous material through the delivery opening.

2. A syringe delivery system as recited in claim 1, wherein the sheath and the syringe barrel each comprise a pair of spaced apart torque fins to aid in rotating the sheath relative to the syringe barrel.

3. A syringe delivery system as recited in claim 1, wherein the threaded shaft of the plunger stem comprises a central portion of the plunger stem, the plunger stem further comprising a proximal end rigidly fixed relative to the sheath and a distal end including a plunger over the distal end, the plunger being diametrically sized so as to force viscous material within the hollow internal chamber of the syringe barrel out the delivery opening as the syringe barrel is advanced into the sheath.

4. A syringe delivery system as recited in claim 3, wherein the proximal end of the plunger stem includes a radial groove into which a corresponding protrusion of the sheath is received so as to rigidly attach the sheath to the proximal end of the plunger stem.

5. A syringe delivery system as recited in claim 3, wherein the central portion and the distal end of the plunger stem are not directly attached to the sheath.

6. A syringe delivery system as recited in claim 1, wherein the sheath includes a hollow interior cavity having an inside diameter and the syringe barrel includes a proximal portion having an outside diameter that is approximately equal to the inside diameter of the hollow interior cavity of the sheath, and wherein a depth of the hollow interior cavity is approximately equal to a length of the proximal portion of the syringe barrel.

7. A syringe delivery system as recited in claim 1, wherein a ratio of a total length of the syringe delivery system in a configuration when the hollow interior chamber is filled with viscous material and the plunger stem has not been advanced within the syringe barrel to any significant degree relative to a configuration when the plunger stem is fully advanced into the syringe barrel such that the hollow interior chamber is substantially empty of viscous material is between about 2:1 and about 1.25:1.

8. A syringe delivery system as recited in claim 1, wherein a ratio of a total length of the syringe delivery system in a configuration when the hollow interior chamber is filled with viscous material and the plunger stem has not been advanced within the syringe barrel to any significant degree relative to a configuration when the plunger stem is fully advanced into the syringe barrel such that the hollow interior chamber is substantially empty of viscous material is between about 1.75:1 and about 1.5:1.

9. A syringe delivery system as recited in claim 1, further comprising a cap configured to selectively cap the delivery opening at the delivery end of the syringe barrel.

10. A syringe delivery system as recited in claim 9, wherein the cap comprises a flip-top cap hingedly attached to a retaining ring, the retaining ring being configured to be matingly received within a radial groove formed near the delivery end of the syringe barrel.

11. A syringe delivery system as recited in claim 1, wherein said syringe barrel comprise a material that blocks transmission of curing light wavelengths.

12. A syringe delivery system for dispensing a viscous material through a syringe opening comprising:
a syringe barrel having an outer gripping surface disposed near a proximal end of the barrel, a hollow interior chamber for holding a viscous material to be dispensed, and a delivery opening at a delivery end of the barrel through which the viscous material may be dispensed;
a plunger stem including a threaded shaft that threadably engages the syringe barrel, the plunger stem being at least partially disposed within the hollow interior chamber of the syringe barrel for selective longitudinal advancement therein so as to dispense a viscous material from the interior chamber through the delivery opening; and
a generally cylindrical sheath including a longitudinally extending hollow interior cavity, a proximal end of the plunger stem being rigidly attached to the sheath so that the plunger stem rotates in unison with the sheath relative to the syringe barrel, at least the proximal end of the threaded shaft of the plunger stem residing within the hollow interior cavity so that the entirety of the plunger stem is enclosed within the syringe barrel and the sheath during use, the syringe barrel further including a proximal portion which is diametrically sized so as to be progressively received within the hollow interior cavity of the sheath as the syringe barrel is longitudinally advanced into the sheath while the plunger stem simultaneously advances within the syringe barrel so as to dispense a viscous material through the delivery opening.

13. A syringe delivery system as recited in claim 12, wherein the threaded shaft of the plunger stem comprises a central portion of the plunger stem, the plunger stem further comprising a proximal end fixed relative to the sheath and an unthreaded distal end including a plunger over the unthreaded distal end, the central portion and the unthreaded distal end of the plunger stem not being attached to the sheath.

14. A syringe delivery system as recited in claim 12, wherein the proximal portion of the syringe barrel includes an outside diameter that is approximately equal to the inside diameter of the hollow interior cavity of the sheath, and wherein a depth of the hollow interior cavity is approximately equal to a length of the proximal portion of the syringe barrel.

15. A syringe delivery system for dispensing a viscous material through a syringe opening comprising:
a syringe barrel having a hollow interior chamber for containing a viscous material to be dispensed, a delivery opening at a delivery end of the barrel through which the viscous material is dispensed, and an outer gripping surface comprising a pair of laterally extending torque fins disposed near a proximal end of the syringe barrel;
a plunger stem including a threaded shaft that threadably engages a proximal end of the syringe barrel, the plunger stem being at least partially disposed within the hollow interior chamber of the syringe barrel for selective longitudinal advancement therein so as to dispense a viscous material from the interior chamber through the delivery opening; and
a sheath including an outer gripping surface comprising a pair of laterally extending torque fins and a longitudinally extending hollow interior cavity, a proximal end of the plunger stem being rigidly attached to the sheath so that the plunger stem rotates with the sheath relative to the syringe barrel, at least the proximal end of the threaded shaft of the plunger stem residing within the hollow interior cavity, the syringe barrel further including a proximal portion which is diametrically sized so as to be progressively received within the hollow interior cavity of the sheath as the syringe barrel is longitudinally advanced into the sheath while the plunger stem including the threaded shaft simultaneously advances within the syringe barrel so as to dispense a viscous material through the delivery opening.

16. A syringe delivery system as recited in claim 15, wherein the threaded shaft of the plunger stem comprises a central portion of the plunger stem, the plunger stem further comprising a proximal end fixed relative to the sheath and an unthreaded distal end including a plunger over the unthreaded distal end, the plunger being diametrically sized so as to force composite material within the internal chamber of the syringe barrel out the delivery opening as the syringe barrel is advanced into the sheath.

17. A syringe delivery system as recited in claim 16, wherein the central portion and the unthreaded distal end of the plunger stem are not directly attached to the sheath.

18. A syringe delivery system as recited in claim 15, wherein the proximal portion of the syringe barrel includes an outside diameter that is approximately equal to the inside diameter of the hollow interior cavity of the sheath, and wherein a depth of the hollow interior cavity is approximately equal to a length of the proximal portion of the syringe barrel.

19. A syringe delivery system as recited in claim 15, wherein a ratio of a total length of the syringe delivery system in a configuration when the hollow interior chamber is filled with viscous material and the plunger stem has not been advanced within the syringe barrel to any significant degree relative to a configuration when the plunger stem is fully advanced into the syringe barrel such that the hollow interior chamber is substantially empty of viscous material is between about 2:1 and about 1.25:1.

20. A syringe delivery system as recited in claim 15, wherein a ratio of a total length of the syringe delivery system in a configuration when the hollow interior chamber is filled with viscous material and the plunger stem has not been advanced within the syringe barrel to any significant degree relative to a configuration when the plunger stem is fully advanced into the syringe barrel such that the hollow interior chamber is substantially empty of viscous material is between about 1.75:1 and about 1.5:1.
